(19) United States
(12) Patent Application Publication
(10) Pub. No.: US 2026/0117675 A1
(43) Pub. Date: Apr. 30, 2026

(54) HEAT SHIELD FOR ENGINE CONTROL SYSTEM COMPONENTS MOUNTED TO ENGINE CASE OF GAS TURBINE ENGINES

(71) Applicant: Hamilton Sundstrand Corporation, Charlotte, NC (US)

(72) Inventors: Andrew Solomon, Windsor, CT (US); Alden Winn, Glastonbury, CT (US)

(21) Appl. No.: 18/933,280

(22) Filed: Oct. 31, 2024

(51) Int. Cl. F01D 25/14

(52) U.S. Cl. CPC F01D 25/145; F05D 2240/15; F05D 2260/30

(57) ABSTRACT

Apparatus and associated methods relate to a heat shield for Engine Control System (ECS) components mounted to the engine case of gas turbine engines. The heat shield is formed by additive manufacturing, which permits a plurality of structural trusses to be formed between first and second mounting plates separated by a thin elongated cavity. The first mounting plate is configured to mount to the engine case of the gas turbine engine. The second mounting case is configured to mount to the ECS component. The truss structure is configured to add rigidity to the heat shield without providing significant thermal conductivity between the first and second mounting plates.

### BACKGROUND

Various methods of additive manufacturing have been used to create three-dimensional forms, many of which cannot be created using traditional methods of manufacturing. Each of these various methods of additive manufacturing have particular strengths and weaknesses, and each has its requisite equipment and materials that can be used in the production of such three-dimensional forms. One such method is the selective fusing of materials in a granular bed of unfused material. The material is fused in a layer-by-layer fashion, with the unfused material serving to support fused layers thereabove. Following the fusing of the form, the granular materials that remain are removed from the fused form. Such methods of granular material fusing include: i) powder bed and inkjet head 3D printing; ii) electron-beam melting; iii) selective laser melting; iv) selective heat sintering; v) selective laser sintering; and vi) direct metal laser sintering.

### SUMMARY

Some embodiments relate to a heat shield for Engine Control System (ECS) components mounted to an engine case of a gas turbine engine. The heat shield includes a first mounting plate configured to mount to the engine case. The heat shield includes a second mounting plate configured to mount to an ECS component. The heat shield includes a substantially uniform gap separating the first and the second mounting plates. The heat shield includes a sidewall circumscribing and connecting the first and second mounting plate, thereby laterally encapsulating a cavity having a lateral dimension defined by an inside surface of the sidewall and having a thickness of the substantially uniform gap. The heat shield includes a plurality of structural trusses distributed substantially uniformly throughout the cavity. Each of the plurality of structural trusses span the substantially uniform gap between the first and second mounting plates. The heat shield includes a plurality of mounting apertures substantially perpendicular to and providing a straight path through both the first and second mounting plates, thereby providing access to the cavity.

Some embodiments relate to a method for manufacturing a heat shield for Engine Control System (ECS) components mounted to an engine case of a gas turbine engine. In the method, a granular bed of unfused material is provided. A layer of the granular bed is fused to form a first mounting plate configured to mount to the engine case via a first plurality of mounting apertures in the first mounting plate. Portions of the granular bed immediately above the first mounting plate are fused to form a sidewall circumscribing the first mounting plate and a plurality of structural trusses distributed substantially uniformly throughout the first mounting plate. The sidewall and each of the plurality of structural trusses extending a gap thickness above the first mounting plate, the sidewall forming thin elongated cavity having a lateral dimension defined by an inside surface of the sidewall. A layer of the granular bed immediately above the sidewall and the plurality of structural trusses to form a second mounting plate configured to mount to an ECS component via a second plurality of mounting apertures, each aligned with a corresponding one of the first plurality of mounting apertures in the first mounting plate, the second mounting plate enclosing the thin elongated cavity defined by a gap thickness between the first and second mounting plates, Non-fused granular material is then removed via at least one of the first and/or second pluralities of mounting apertures.

### BRIEF DESCRIPTION OF THE DRAWINGS

FIG. 1 is a schematic diagram depicting an additively manufactured heat shield used to mount an engine control system to an engine case of a gas turbine engine.

FIG. 2 is a perspective view of an embodiment of an additively manufactured heat shield.

FIG. 3 is a schematic diagram depicting an additively manufactured heat shield configured to facilitate cooling via airflow through a thin elongated cavity therewithin.

FIG. 4 is a flow chart of a method for manufacturing a heat shield having a plurality of structural trusses formed between first and second mounting plates separated by a thin elongated cavity.

### DETAILED DESCRIPTION

Apparatus and associated methods relate to a heat shield for Engine Control System (ECS) components mounted to the engine case of gas turbine engines. The heat shield is formed by additive manufacturing, which permits a plurality of structural trusses to be formed between first and second mounting plates separated by a thin elongated cavity. The first mounting plate is configured to mount to the engine case of the gas turbine engine. The second mounting case is configured to mount to the ECS component. The truss structure is configured to add rigidity to the heat shield without providing significant thermal conductivity between the first and second mounting plates.

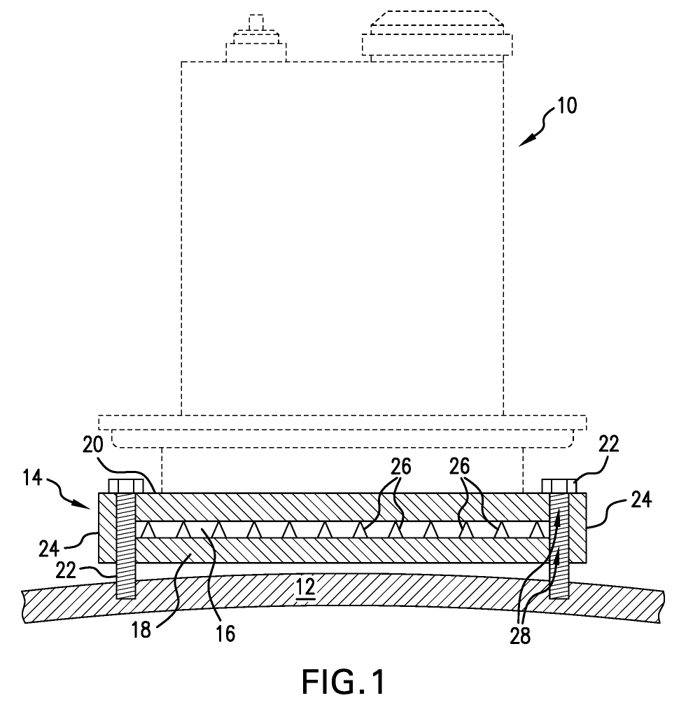

FIG. 1 is a schematic diagram depicting an additively manufactured heat shield for mounting an ECS component to an engine case of a gas turbine engine. In FIG. 1, ECS component 10 is attached to engine case 12 via heat shield 14. ECS component 10 can include actuators, sensors, electronics, etc. or any combination thereof, which are used to control one or more of the various controllable aspects of a gas turbine engine. ECS components, such as ECS component 10, are often mounted at locations that receive heat from the gas turbine engine. As such, ECS components often require some method of maintaining a temperature that is below some high-temperature limit. Heat shield 14 is configured to facilitate such maintenance of temperature below a high-temperature limit. To do so, heat shield 14 is designed with thin elongated cavity 16 formed between first and second mounting plates 18 and 20. Thin elongated cavity 16 is designed to inhibit thermal conduction between first and second mounting plates 18 and 20.

ECS component 10 is mounted on the side opposite to engine case 12 of heat shield 14. ECS component 10 can be mounted to second mounting plate 20 in a variety of manners as are known in the art. Typically, each of ECS component 10 and engine case 12 are directly mounted to heat shield 14. First and second mounting plates 18 and 20 are connected to one another via sidewall 24 and structural trusses 26. Structural trusses 26 are designed to add rigidity to heat shield 14 while providing little thermal conductivity between first and second mounting plates 18 and 20. Each of structural trusses 26 has a longitudinal dimension as measured along a longitudinal direction of the structural truss between attachment locations (e.g., points of attachment) at first and second mounting plates 18 and 20. Each of structural trusses 26 has lateral dimensions in lateral directions perpendicular to the longitudinal direction of the structural truss. The lateral dimensions are much smaller than the longitudinal dimension so as to limit the thermal conductivity of each structural truss. Typically, a ratio between a lateral dimensions and the longitudinal dimension is less than 10%, 5%, 3%, or 2%.

Sidewall 24 can be made thin to further inhibit thermal conductivity between first and second mounting plates 18 and 20. Thin elongated cavity 16 is laterally circumscribed by sidewall 24 and vertically bounded by first and second mounting plates 18 and 20. Thin elongated cavity 16 has lateral dimensions defined between inside surfaces of sidewall 24 on opposite lateral sides of heat shield 14. Thin elongated cavity 16 has a thickness defined by a separation distance between inside surfaces of first and second mounting plates 18 and 20. Typically the thickness of thin elongated cavity 16 is substantially uniform throughout the lateral dimensions of thin elongated cavity 16. For example, thickness of thin elongated cavity 16 can be within +/- 20%, 12%, 10%, 5%, or less. In some embodiments, first and second mounting plates 18 and 20 are substantially planar, thereby creating thin elongated cavity 16 of substantially uniform thickness. For example, any curvature of first and second mounting plates 18 and 20 can be less than 10°, 5°, 3°, or less, and thicknesses of first and second mounting plates 18 and 20 can be within +/- 20%, 12%, 10%, 5%, or less throughout their lateral dimensions. In other embodiments first mounting plate 18 and/or second mounting plate 20 can be curved so as to match a curved shape of engine case 12, to which they are mounted. Thin elongated cavity 16 can have a thickness that is less than 10%, 5%, 3%, or 2% of a lateral dimension as measured between inside surfaces of sidewall 24 at opposite lateral sides of the heat shield 14.

Structural trusses 26 are distributed throughout thin elongated cavity 16, thereby strengthening heat shield 14 throughout its lateral dimensions. Mounting apertures 28 are formed substantially perpendicular to and providing a straight path through both first and second mounting plates 18 and 20. For example, mounting apertures 28 can extend from first and second mounting plates 18 and 20 within 10°, 5°, 3°, or less from a direction normal to first and second mounting plates 18 and 20. Mounting apertures 28 provide access to thin elongated cavity 16, which can provide a means for removing non-fused granular material that remains therein after heat shield 14 has been additively manufactured. Mounting apertures 28 and fasteners 22 can be configured to seal thin elongated cavity 16 when heat shield 14 is mounted to engine case 12, thereby isolating thin elongated cavity 16 from an exterior environment. In some embodiments, thin elongated cavity 16 can be filled with an inert gas or a gas with very little moisture (e.g., less than a fraction of a percent). Because heat shield 14 is additively manufactured, first and second mounting plates 18 and 20, sidewall 24, and structural trusses 26 are fixedly connected to one another, thereby forming a unitary body. In some embodiments first and second mounting plates 18 and 20, sidewall 24, and structural trusses 26 are made of the same material – a common material for heat shield 14. In other embodiments, the material of the granular bed is changed for different layers, thereby resulting in different materials or different compositions of a material for different members of heat shield 14.

Structural trusses 26 can be formed in a variety of geometries and can be distributed throughout thin elongated cavity 16 in a variety of manners. For example, in some embodiments, structural trusses 26 can be oriented so as to have longitudinal axes that are perpendicular to the inside surfaces of first and second mounting plates 18 and 20. In other embodiments, structural trusses can be oriented so that their longitudinal exes are at a non-zero angle of incidence with the inside surfaces of first and second mounting plates 18 and 20. In such angled embodiments, such as in the depicted embodiment, subsets of structural trusses 26 can be oriented in different directions from one another. A first subset can be oriented such that the acute angles of incidence are included within planes oriented in a first direction (i.e., in the plane of the paper), while a second subset can be oriented such that the acute angles of incidence are included within planes parallel to those of the first subset, but with the acute angle directed in opposite directions than those of the first subset. Still other subsets can be oriented such that the acute angles of incidences are included within planes oriented perpendicular to the planes of the first and second subsets (i.e., in planes oriented into and out of the paper).

Structural trusses 26 can have a net thermal conductivity between first and second mounting plates 18 and 20 that is less than a thermal conductivity of sidewall 24 therebetween. Structural trusses 26 and/or sidewall 24 can have a net thermal conductivity between first and second mounting plates 18 and 20 that is less than a thermal conductivity associated with convection of gases within thin elongated cavity 16.

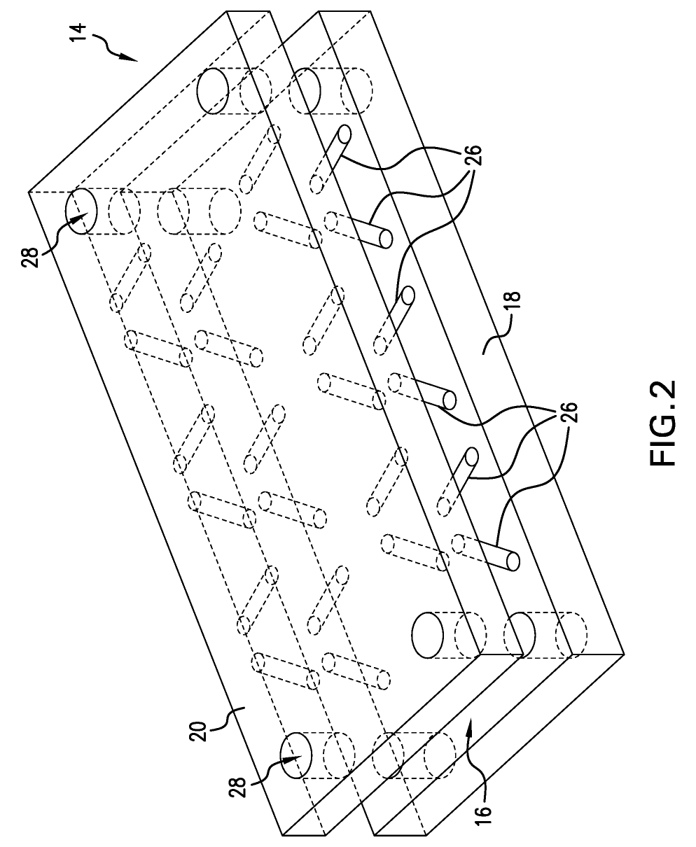

FIG. 2 is a perspective view of an embodiment of an additively manufactured heat shield. In FIG. 2, heat shield 14 includes thin elongated cavity 16, which has been formed between first and second mounting plates 18 and 20. Structural trusses 26 provide rigidity and support to mounting plates 18 and 20. Additively manufacturing heat shield 14 typically results in a heat shield 14 that is a unitary body, whereby first and second mounting plates 18 and 20 are rigidly secured to one another by structural trusses 26 without need of fasteners, adhesives, glue, solder, etc. Moreover, because structural trusses 26 are created using additive manufacturing, structural trusses 26 are created in a layer-by-layer fashion, thereby permitting creation of thin elongated cavity 16 without having to subsequently weld, braze, solder, etc. structural trusses 26 to one of first and second mounting plates 18 and 20. In the depicted embodiment, no sidewall is formed around thin elongated cavity 16. In other embodiments, sidewall 24 is formed along with structural trusses 26.

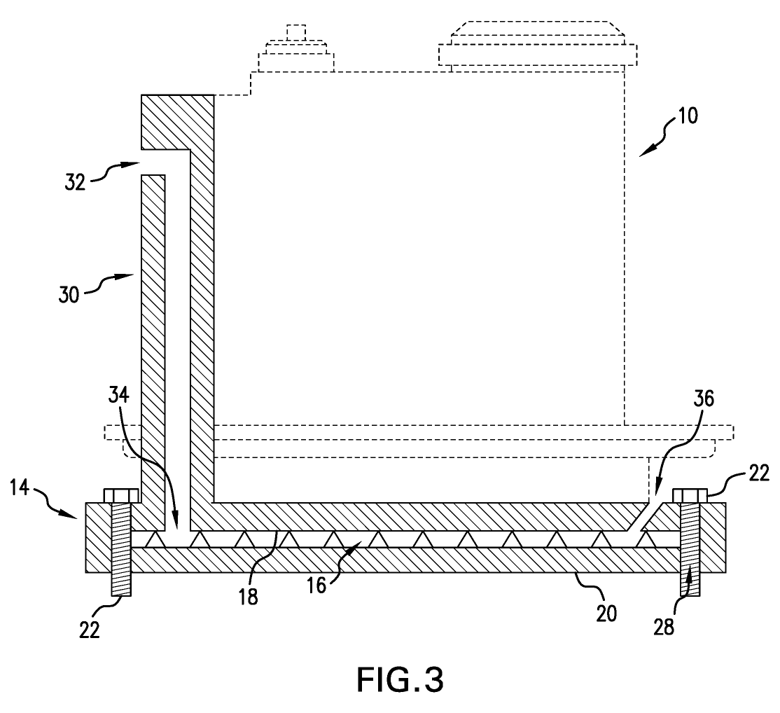

FIG. 3 is a schematic diagram depicting an additively manufactured heat shield configured to facilitate cooling via airflow through a thin elongated cavity therewithin. In FIG. 3, thin elongated cavity 16 is not isolated from the exterior environment, but instead is cooled by airflow directed therethrough. In the depicted embodiment, heat shield 14 includes air duct 30, which extends from second mounting plate 20. Air duct 30 has inlet 32 configured to receive cool air from a cool air location within or near the gas turbine engine. Air can be considered to be cool air if its temperature is less than a threshold temperature at which the ECS component 10 can operate. Air duct 30 delivers the cool air received via inlet 32 to thin elongated cavity 16 via inlet aperture 34 in second mounting plate 20. After flowing through thin elongated cavity 16, airflow is expelled via outlet aperture 36 in second mounting plate 20. In some embodiments, inlet and outlet apertures 34 and 36 can be located in other locations, such as, for example, in sidewall 24. In some embodiments, mounting apertures 28 can be larger in second mounting plate 20 than they are in first mounting plate 18. In such embodiments, fasteners 22 can pass through second mounting plate 20 and attach heat shield 14 to engine case 12 via first mounting plate 18. The larger apertures 28 in second mounting plate 20 can then be used for conducting airflow into and/or out of thin elongated cavity 16. In some embodiments, structural trusses 26 can be thin vertical walls formed in heat-exchanger fashion. Such thin vertical walls can direct airflow through thin elongated cavity 16 as well as provide large surface areas for transmitting heat from heat shield 14 to the airflow.

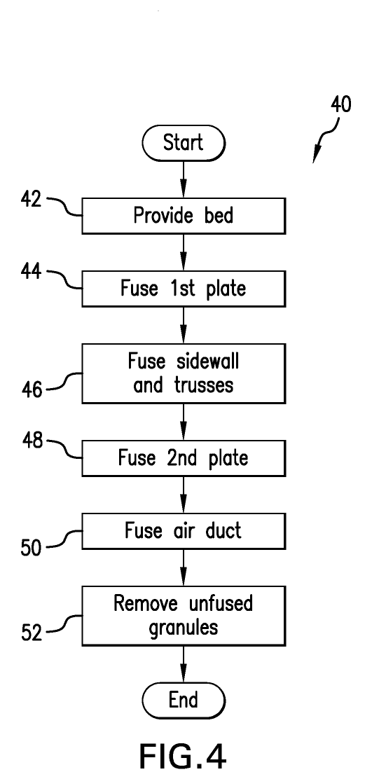

FIG. 4 is a flow chart of a method for manufacturing a heat shield having a plurality of structural trusses formed between first and second mounting plates separated by a thin elongated cavity. In FIG. 4, method 40 begins at step 42 where a granular bed of unfused material is provided. Method 40 then advances to step 44 where a layer of the granular bed is fused to form first mounting plate 18, which is configured to be mounted to engine case 12 via mounting apertures 28 in first mounting plate 18. Method 40 then advances to step 46 where portions of the granular bed immediately above first mounting plate 18 are fused to form sidewall 24 circumscribing first mounting plate 18 and structural trusses 26 distributed substantially uniformly throughout first mounting plate 18. Sidewall 24 and each of structural trusses 26 extend a gap thickness above first mounting plate 18. Sidewall 24 forms thin elongated cavity 16 having lateral dimensions defined by an inside surface of sidewall 24 Method 40 then advances to step 48 where a layer of the granular bed immediately above sidewall 24 and structural trusses 26 to form second mounting plate 20, which is configured to mount to ECS component 10 via mounting apertures 28 in second mounting plate 20. Each mounting apertures 28 in second mounting plate 20 are aligned with a corresponding one of mounting apertures 28 in first mounting plate 18. Second mounting plate 20 enclosing thin elongated cavity 16 defined by a gap thickness between first and second mounting plates 18 and 20. Method 40 then advances to step 50 where a layer of the granular bed immediately above second mounting plate 20 is fused to form air duct 30, which extends from second mounting plate 20. Air duct 30 has inlet 32 configured to receive relatively cool air from a cool air location within or near the gas turbine engine. Air duct 30 is configured to deliver the relatively cool air received via inlet 32 to thin elongated cavity 16 via inlet aperture 34 in second mounting plate 20. Method 40 then advances to step 52 where non-fused granular material is removed via mounting apertures 28.

### Discussion of Possible Embodiments

The following are non-exclusive descriptions of possible embodiments of the present invention.

Some embodiments relate to a heat shield for Engine Control System (ECS) components mounted to an engine case of a gas turbine engine. The heat shield includes a first mounting plate configured to mount to the engine case. The heat shield includes a second mounting plate configured to mount to an ECS component. The heat shield includes a substantially uniform gap separating the first and the second mounting plates. The heat shield includes a sidewall circumscribing and connecting the first and second mounting plate, thereby laterally encapsulating a cavity having a lateral dimension defined by an inside surface of the sidewall and having a thickness of the substantially uniform gap. The heat shield includes a plurality of structural trusses distributed substantially uniformly throughout the cavity. Each of the plurality of structural trusses span the substantially uniform gap between the first and second mounting plates. The heat shield includes a plurality of mounting apertures substantially perpendicular to and providing a straight path through both the first and second mounting plates, thereby providing access to the cavity.

The heat shield of the preceding paragraph can optionally include, additionally and/or alternatively, any one or more of the following features, configurations and/or additional components:

A further embodiment of the foregoing heat shield, wherein each of the first and second mounting plates can be substantially planar and the first and second mounting plates are parallel to one another.

A further embodiment of any of the foregoing heat shields, wherein a cavity thickness can be less than 5% of a lateral cavity dimension as measured between an inside surface of the sidewall at opposite lateral sides of the heat shield.

A further embodiment of any of the foregoing heat shields, wherein the first and second mounting plate, the sidewall, and the plurality of structural trusses can be fixedly connected to one another, thereby forming a unitary body.

A further embodiment of any of the foregoing heat shields, wherein the first and second mounting plate, the sidewall, and the plurality of structural trusses can consist of a common material.

A further embodiment of any of the foregoing heat shields, wherein the first and second mounting plate, the sidewall, and the plurality of structural trusses can be fixedly connected to one another without a material other than the common material.

A further embodiment of any of the foregoing heat shields, wherein the plurality of trusses can be distributed throughout the cavity in a regular array.

A further embodiment of any of the foregoing heat shields, wherein each of the plurality of trusses can have a longitudinal dimension as measured between connection points to the first and second mounting plates and lateral dimensions perpendicular to the longitudinal dimension, each of the lateral dimensions being less than 10% of the longitudinal dimension of the structural trusses.

A further embodiment of any of the foregoing heat shields, wherein each of the plurality of trusses can have the longitudinal dimension directed along an axis substantially normal to the first and second mounting plates at the points of attachment thereto.

A further embodiment of any of the foregoing heat shields, wherein each of the plurality of trusses can have the longitudinal dimension directed along an axis that has an angle of incidence with each of the first and second mounting plates at the points of attachment thereto, the angle of incidence being greater than 30 degrees.

A further embodiment of any of the foregoing heat shields, wherein the plurality of trusses can include subsets, each of the subsets having structural trusses with longitudinal dimensions that are directed parallel to one another and differently than those of the other subsets.

A further embodiment of any of the foregoing heat shields, wherein each of the plurality of mounting apertures can be configured to be sealed by a mounting fastener passing therethrough and securing the heat shield to the engine case of the gas turbine engine.

A further embodiment of any of the foregoing heat shields, wherein the cavity can be isolated from an exterior environment in response to the plurality of mounting apertures being sealed by a corresponding plurality of mounting fasteners.

A further embodiment of any of the foregoing heat shields, wherein the cavity can be filled with an inert gas.

A further embodiment of any of the foregoing heat shields, wherein the second mounting plate can have an inlet aperture and an outlet aperture, wherein airflow, which is generated while the gas turbine engine is operating, follows a path into the cavity via the inlet aperture, through the cavity, and out of the cavity via the outlet aperture.

Some embodiments relate to a method for manufacturing a heat shield for Engine Control System (ECS) components mounted to an engine case of a gas turbine engine. In the method, a granular bed of unfused material is provided. A layer of the granular bed is fused to form a first mounting plate configured to mount to the engine case via a first plurality of mounting apertures in the first mounting plate. Portions of the granular bed immediately above the first mounting plate are fused to form a sidewall circumscribing the first mounting plate and a plurality of structural trusses distributed substantially uniformly throughout the first mounting plate. The sidewall and each of the plurality of structural trusses extending a gap thickness above the first mounting plate, the sidewall forming thin elongated cavity having a lateral dimension defined by an inside surface of the sidewall. A layer of the granular bed immediately above the sidewall and the plurality of structural trusses to form a second mounting plate configured to mount to an ECS component via a second plurality of mounting apertures, each aligned with a corresponding one of the first plurality of mounting apertures in the first mounting plate, the second mounting plate enclosing the thin elongated cavity defined by a gap thickness between the first and second mounting plates, Non-fused granular material is then removed via at least one of the first and/or second pluralities of mounting apertures.

The method of the preceding paragraph can optionally include, additionally and/or alternatively, any one or more of the following features, configurations and/or additional components:

A further embodiment of the foregoing method can further include fusing a layer of the granular bed immediately above the second mounting plate to form an air duct extending from the second mounting plate. The air duct can have an inlet configured to receive relatively cool air from a cool air location within or near the gas turbine engine. The air duct can deliver the relatively cool air received via the inlet to the cavity via an aperture in the second mounting plate.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A heat shield for Engine Control System (ECS) components mounted to an engine case of a gas turbine engine, the heat shield comprising:
a first mounting plate configured to mount to the engine case;
a second mounting plate configured to mount to an ECS component;
a substantially uniform gap separating the first and the second mounting plates;
a sidewall circumscribing and connecting the first and second mounting plate, thereby laterally encapsulating a cavity having a lateral dimension defined by an inside surface of the sidewall and having a thickness of the substantially uniform gap;
a plurality of structural trusses distributed substantially uniformly throughout the cavity, each of the plurality of structural trusses spanning the substantially uniform gap between the first and second mounting plates; and
a plurality of mounting apertures substantially perpendicular to and providing a straight path through both the first and second mounting plates, thereby providing access to the cavity.

2. The heat shield of claim 1, wherein each of the first and second mounting plates is substantially planar and the first and second mounting plates are parallel to one another.

3. The heat shield of claim 1, wherein a cavity thickness is less than 5% of the lateral dimension of the cavity as measured between an inside surface of the sidewall at opposite lateral sides of the heat shield.

4. The heat shield of claim 1, wherein the first and second mounting plate, the sidewall, and the plurality of structural trusses are fixedly connected to one another, thereby forming a unitary body.

5. The heat shield of claim 4, wherein the first and second mounting plate, the sidewall, and the plurality of structural trusses consist of a common material.

6. The heat shield of claim 5, wherein the first and second mounting plate, the sidewall, and the plurality of structural trusses are fixedly connected to one another without a material other than the common material.

7. The heat shield of claim 1, wherein the plurality of trusses is distributed throughout the cavity in a regular array.

8. The heat shield of claim 1, wherein each of the plurality of trusses has a longitudinal dimension as measured between connection points to the first and second mounting plates and lateral dimensions perpendicular to the longitudinal dimension, each of the lateral dimensions being less than 10% of the longitudinal dimension of the structural trusses.

9. The heat shield of claim 8, wherein each of the plurality of trusses has the longitudinal dimension directed along an axis substantially normal to the first and second mounting plates at the points of attachment thereto.

10. The heat shield of claim 9, wherein each of the plurality of trusses has the longitudinal dimension directed along an axis that has an angle of incidence with each of the first and second mounting plates at the points of attachment thereto, the angle of incidence being greater than 30 degrees.

11. The heat shield of claim 10, wherein the plurality of trusses comprises subsets, each of the subsets having structural trusses with longitudinal dimensions that are directed parallel to one another and differently than those of the other subsets.

12. The heat shield of claim 1, wherein each of the plurality of mounting apertures is configured to be sealed by a mounting fastener passing therethrough and securing the heat shield to the engine case of the gas turbine engine.

13. The heat shield of claim 1, wherein the cavity is isolated from an exterior environment in response to the plurality of mounting apertures being sealed by a corresponding plurality of mounting fasteners.

14. The heat shield of claim 1, wherein the cavity is filled with an inert gas.

15. The heat shield of claim 1, wherein the second mounting plate has an inlet aperture and an outlet aperture, wherein airflow, which is generated while the gas turbine engine is operating, follows a path into the cavity via the inlet aperture, through the cavity, and out of the cavity via the outlet aperture.

16. The heat shield of claim 15, further comprising:
an air duct extending from the second mounting plate, the air duct having an inlet configured to receive cool air from a cool air location within or near the gas turbine engine, the air duct delivering the relatively cool air received via the inlet to the cavity via an aperture in the second mounting plate.

17. The heat shield of claim 1, wherein the plurality of structural trusses has a thermal conductivity between the first and second mounting plates that is less than a thermal conductivity of the sidewall therebetween.

18. The heat shield of claim 1, wherein the plurality of structural trusses has a thermal conductivity between the first and second mounting plates that is less than a thermal conductivity associated with convection of gases within the cavity between the first and second mounting plates.

19. A method for manufacturing a heat shield for Engine Control System (ECS) components mounted to an engine case of gas turbine engine, the method comprising:
providing a granular bed of unfused material;
fusing a layer of the granular bed to form a first mounting plate configured to mount to the engine case via a first plurality of mounting apertures in the first mounting plate;
fusing portions of the granular bed immediately above the first mounting plate to form a sidewall circumscribing the first mounting plate and a plurality of structural trusses distributed substantially uniformly throughout first mounting plate, the sidewall and each of the plurality of structural trusses extending a gap thickness above the first mounting plate, the sidewall forming thin elongated cavity having a lateral dimension defined by an inside surface of the sidewall;
fusing a layer of the granular bed immediately above the sidewall and the plurality of structural trusses to form a second mounting plate configured to mount to an ECS component via a second plurality of mounting apertures in the second mounting plate, each of the second plurality of mounting apertures aligned with a corresponding one of the first plurality of mounting apertures in the first mounting plate, the second mounting plate enclosing the thin elongated cavity defined by a gap thickness between the first and second mounting plates; and
removing non-fused granular material via at least one of the first and/or second pluralities of mounting apertures.

20. The method of claim 19, further comprising:
fusing a layer of the granular bed immediately above the second mounting plate to form an air duct extending from the second mounting plate, the air duct having an inlet configured to receive relatively cool air from a cool air location within or near the gas turbine engine, the air duct delivering the relatively cool air received via the inlet to the cavity via an aperture in the second mounting plate.
